(19) United States
(12) Patent Application Publication
(10) Pub. No.: US 2026/0126939 A1
(43) Pub. Date: May 7, 2026

(54) NON-TRANSITORY COMPUTER-READABLE STORAGE MEDIUM STORING PRINT CONTROL PROGRAM, PRINT CONTROL APPARATUS, AND CONTROL METHOD

(71) Applicant: SEIKO EPSON CORPORATION, Tokyo (JP)

(72) Inventor: Ryosuke NASUNO, Nagano (JP)

(21) Appl. No.: 19/373,821

(22) Filed: Oct. 30, 2025

(30) Foreign Application Priority Data
Nov. 1, 2024 (JP) 2024-192737

(51) Int. Cl. G06F 3/12

(52) U.S. Cl. CPC G06F 3/1225; G06F 3/1204; G06F 3/1254; G06F 3/1262; G06F 3/1288

(57) ABSTRACT

Provided is a non-transitory computer-readable storage medium storing a print control program causing a computer to function as a PSA that extends a general-purpose printer driver. The PSA includes a print job acquisition section that acquires a print job from the general-purpose printer driver, and a display control section that accepts a selection of whether to cause a combined print application to process the print job.

The present application is based on, and claims priority from JP Application Serial Number 2024-192737, filed Nov. 1, 2024, the disclosure of which is hereby incorporated by reference herein in its entirety.

### BACKGROUND

### 1. Technical Field

The present disclosure relates to a non-transitory computer-readable storage medium storing a print control program, a print control apparatus, and a control method.

### 2. Related Art

JP-A-2021-107999 discloses an extension application for extending a function of an operating system (hereinafter referred to as an OS) standard driver incorporated in an OS as a standard. The extension application has a job combining function of handling a plurality of print jobs as one print job.

In the configuration of JP-A-2021-107999, since the extension application has the job combining function, the extension application could not avoid becoming bloated.

### SUMMARY

There is provided a non-transitory computer-readable storage medium storing a print control program, the print control program causing a computer to function as a print extension application for extending a general-purpose printer driver, in which the print extension application includes a print job acquisition unit configured to acquire a print job from the general-purpose printer driver, and a selection accepting unit configured to accept a selection of whether to cause an external application to process the print job.

There is provided a print control apparatus including a general-purpose printer driver and a print extension application configured to extend the general-purpose printer driver, in which the print extension application includes a print job acquisition unit configured to acquire a print job from the general-purpose printer driver, and a selection accepting unit configured to accept a selection of whether to cause an external application to process the print job.

There is provided a control method for a print control apparatus including a general-purpose printer driver and a print extension application configured to extend the general-purpose printer driver, the control method including acquiring, by the print extension application, a print job from the general-purpose printer driver, and accepting, by the print extension application, a selection of whether to cause an external application to process the print job.

### BRIEF DESCRIPTION OF THE DRAWINGS

FIG. 1 is a block diagram of a printing system.

FIG. 2 is a block diagram of a computer.

FIG. 3 is a diagram illustrating a print setting dialog by a general-purpose printer driver.

FIG. 4 is a diagram illustrating a print setting dialog by a PSA.

FIG. 5 is a diagram illustrating a warning dialog.

FIG. 6 is a diagram illustrating a Windows form.

FIG. 7 is a control flow of the printing system.

FIG. 8 is a control flow of the printing system.

### DESCRIPTION OF EMBODIMENTS

The present disclosure will be described through embodiments of the present disclosure hereafter; however, the description is not intended to limit the disclosure according to the appended claims to the following embodiments. In addition, not all of the configurations described in the embodiments are essential as units that solve the problem. For clarification of the description, the following description and drawings are appropriately omitted and simplified. In the drawings, the same elements are denoted by the same reference numerals, and redundant descriptions thereof will be omitted as appropriate.

In the following embodiments, when necessary for convenience, the explanation is divided into multiple sections or embodiments; however, unless explicitly and specifically stated otherwise, these are not unrelated to each other, but one represents a modification, application, detailed explanation, supplementary explanation, or the like of part or all of the other. Furthermore, in the following embodiments, when referring to the number of elements and the like (including quantity, numerical value, amount, and range), unless explicitly and specifically stated otherwise or unless clearly limited to a specific number in principle, or other such cases, the number is not limited to that specific value and may be equal to or greater than or equal to or less than the specific number.

Moreover, in the following embodiments, the components (including operational steps) are not necessarily essential unless explicitly and specifically stated otherwise or unless they are clearly considered essential in principle, or other such cases. Similarly, in the following embodiments, when referring to the shape, positional relationship, or the like of components or other factors, unless explicitly and specifically stated otherwise or unless clearly considered otherwise in principle, or other such cases, this includes shapes or the like that are substantially approximate or similar. This also applies to the above number of elements and the like (including quantity, numerical value, amount, and range).

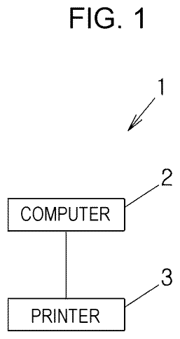

FIG. 1 is a block diagram illustrating an example of a printing system according to the present disclosure. A printing system 1 includes a computer 2 and a printer 3. The computer 2 and the printer 3 are communicably connected to each other via wired or wireless communication. For example, the computer 2 may be communicably connected to the printer 3 via a local area network (LAN) such as a wireless LAN. Further, the computer 2 may be communicably connected to the printer 3 via the Internet, for example.

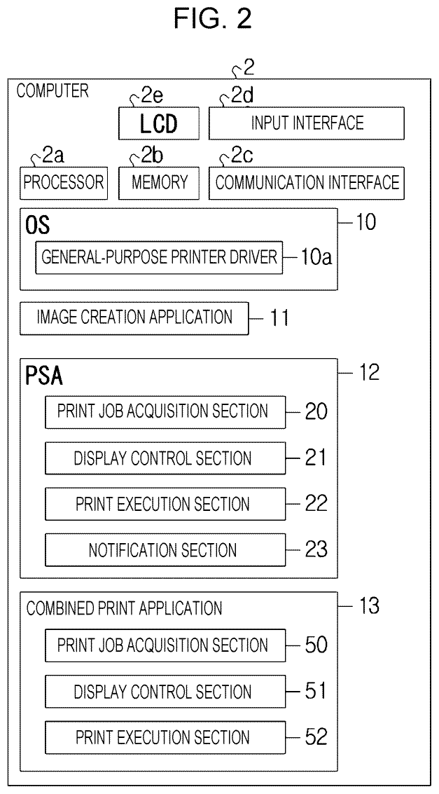

FIG. 2 illustrates a block diagram of the computer 2. As illustrated in FIG. 2, the computer 2 includes a processor 2a, a memory 2b, a communication interface 2c, an input interface 2d, and a liquid crystal display (LCD) 2e.

The input interface 2d is typically a pointing device or a keyboard. The input interface 2d may be a touch panel superimposed on the LCD 2e.

The processor 2a is any of various processors such as a central processing unit (CPU), a graphics processing unit (GPU), or a field-programmable gate array (FPGA). The memory 2b is a main storage device implemented using random access memory (PAM) or the like, or an auxiliary storage device implemented using a hard disk, solid state drive (SSD), memory card, or read-only memory (ROM) or the like. The processor 2a can access the memory 2b. The processor 2a communicates with the printer 3 via the communication interface 2c. The memory 2b stores a program for implementing a predetermined function. The processor 2a reads and executes a program stored in the memory 2b. Accordingly, the processor 2a causes hardware such as the processor 2a, the memory 2b, and the communication interface 2c to function as an operating system (OS) 10, an image creation application 11, a print support application (PSA) 12, and a combined print application 13.

The image creation application 11 is a specific example of a user application. The user application is not limited to the image creation application 11, and may be a document creation application, a presentation material creation application, or a spreadsheet application. The PSA 12 is a specific example of a print extension application. The combined print application 13 is a specific example of an external application.

The OS 10 is basic software for controlling the operation of the computer 2. The OS 10 may be, for example, Windows (registered trademark), but is not limited to this. In the following description, an example in which the OS 10 is Windows will be described.

The OS 10 includes a general-purpose printer driver 10a (application programming interface). The general-purpose printer driver 10a is a printer driver that provides standard printing functions provided by Windows. The general-purpose printer driver 10a executes various processes when called by user applications such as the image creation application 11. The general-purpose printer driver 10a is installed on the computer 2 together with the OS 10. The general-purpose printer driver 10a can also be said to be a printing function that accompanies the OS 10.

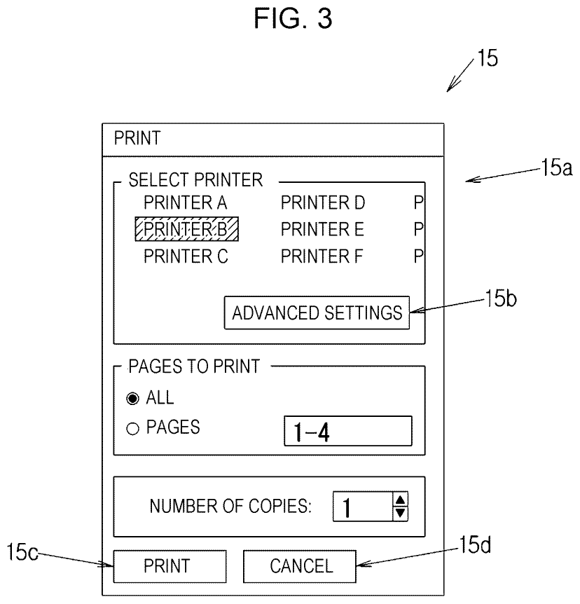

When the image creation application 11 calls the above-mentioned general-purpose printer driver 10a, the image creation application 11 converts the image data created by the user using the image creation application 11 into print data in XML paper specification (XPS) format or graphics device interface (GDI) format and transmits it to the general-purpose printer driver 10a. Then, the general-purpose printer driver 10a displays a standard Windows print setting dialog 15 as illustrated in FIG. 3 on the LCD 2e. This print setting dialog 15 is also called print dialog, print setup dialog, common print dialog, or system print dialog.

The print setting dialog 15 typically displays a print setting unit 15a, a PSA calling button 15b, a print execution button 15c, and a print cancel button 15d.

The print setting unit 15a displays various items so that the user can input print settings. These various items typically include a list box for selecting a printer to use for printing, radio buttons and a text box for setting the range of pages to be printed, and a text box for setting the number of copies to be printed.

The PSA calling button 15b is a button for activating the PSA 12. When the PSA calling button 15b is pressed in a state in which a printer to be used for printing is selected, the general-purpose printer driver 10a activates the PSA 12, transmits, to the PSA 12, a print job including print data received from the image creation application 11 and print settings set via the print setting unit 15a, and closes the print setting dialog 15.

The print execution button 15c is a button for the general-purpose printer driver 10a to execute printing.

The print cancel button 15d is a button for closing the print setting dialog 15.

Referring back to FIG. 2, the PSA 12 includes a print job acquisition section 20, a display control section 21, a print execution section 22, and a notification section 23.

The print job acquisition section 20 is a specific example of a print job acquisition unit. When the PSA 12 is activated, a print job is acquired from the general-purpose printer driver 10a. The print job includes print data and print setting information. The print data is in XPS or GDI format.

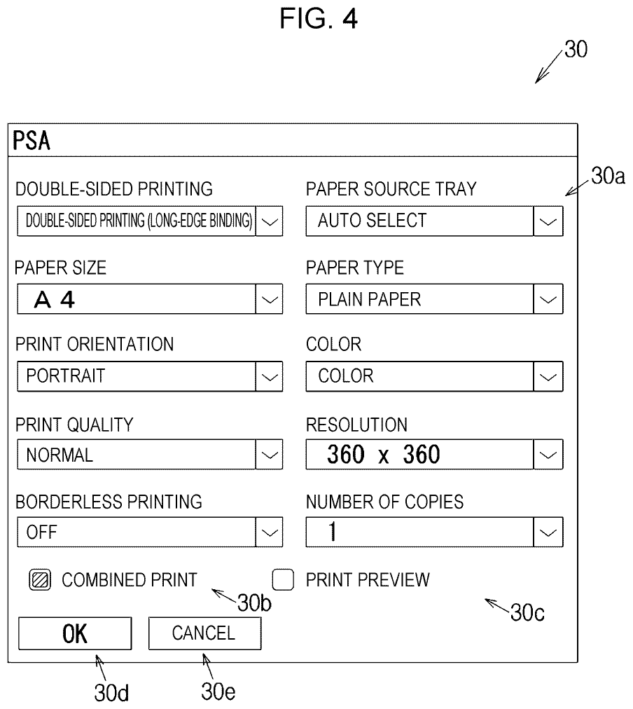

The display control section 21 is a specific example of a selection accepting unit. The display control section 21 displays a print setting dialog 30 as illustrated in FIG. 4 on the LCD 2e when the PSA 12 is activated. The print setting dialog 30 typically displays a print setting unit 30a, a combined print application use selection unit 30b, a print preview display selection unit 30c, a print execution button 30d, and a print cancel button 30e.

The print setting unit 30a is typically composed of a plurality of pull-down menus so that the user can input print settings. The print setting unit 30a displays more items than the number of items that can be set in the print setting unit 15a provided by the general-purpose printer driver 10a as illustrated in FIG. 3.

The combined print application use selection unit 30b is typically composed of a check box so that the user can select whether to cause the combined print application 13 to process the print job.

The print preview display selection unit 30c is typically composed of a check box so that the user can select whether to display the print preview when the print execution button 30d is pressed.

The print execution section 22 is a specific example of a print job transmission unit and a termination processing unit. The print execution section 22 executes predetermined print processing in response to pressing of the print execution button 30d. Specifically, when the user does not select to cause the combined print application 13 to process the print job via the combined print application use selection unit 30b, the print execution unit 22 updates the print job, based on the print setting input by the user via the print setting unit 30a, transmits the print job to the general-purpose printer driver 10a or a printer driver provided by a vendor, and executes the termination processing of the PSA 12.

On the other hand, when the user selects to cause the combined print application 13 to process the print job via the combined print application use selection unit 30b, the print execution section 22 updates the print job, based on the print setting input by the user via the print setting unit 30a, activates the combined print application 13, and transmits the print job to the combined print application 13. Then, when the print execution section 22 receives, from the combined print application 13, a storage completion notification indicating that the print job has been received, the print execution section 22 executes termination processing of the PSA 12.

The notification section 23 is a specific example of a notification unit. When the print execution section 22 fails to activate the combined print application 13, the notification section 23 executes a notification related to the failure of the activation of the combined print application 13. That is, typically, the notification section 23 determines that the print execution section 22 has failed to activate the combined print application 13 when a response from the combined print application 13 cannot be detected for a predetermined time after the print execution section 22 executes the executable file of the combined print application 13. Additionally, the notification section 23 may determine that the print execution section 22 has failed to activate the combined print application 13 when the executable file of the combined print application 13 cannot be found for a predetermined time after the print execution section 22 searches for the executable file of the combined print application 13.

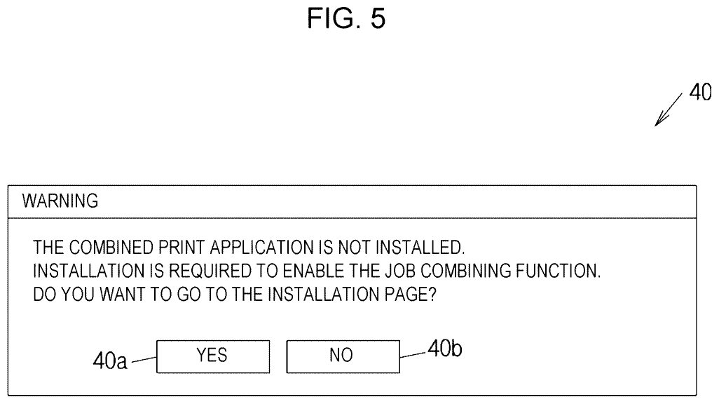

The execution of the notification by the notification section 23 means, for example, that the notification section 23 displays a warning dialog 40 on the LCD 2e as illustrated in FIG. 5. The notification section 23 notifies the user via the warning dialog 40 that the combined print application 13 is not installed and that the combined print application 13 needs to be installed to enable the job combining function, and displays an install button 40a and a cancel button 40b on the warning dialog 40. When the install button 40a is pressed, the notification section 23 activates the web browser application installed on the computer 2 and displays a service site from which the installation program of the combined print application 13 can be downloaded on the web browser application. When the cancel button 40b is pressed, the notification section 23 closes the warning dialog 40. Thus, the user can operate the print setting dialog 30 again.

Further, when the combined print application 13 is not installed, the notification section 23 may execute a notification related to the fact that the combined print application 13 is not installed. That is, the notification section 23 may determine whether the executable file of the combined print application 13 is present in the memory 2b at an appropriate timing, and may display the warning dialog 40 illustrated in FIG. 5 on the LCD 2e at an appropriate timing when the executable file of the combined print application 13 is not present in the memory 2b. The timing of this notification is, for example, a timing at which the PSA 12 is activated, a timing at which a status change event of the combined print application use selection unit 30b occurs, or a timing at which the print execution button 30d is pressed, but is not limited thereto.

Referring back to FIG. 2, the combined print application 13 includes a print job acquisition section 50, a display control section 51, and a print execution section 52.

The print job acquisition section 50 acquires a print job from the PSA 12 when the combined print application 13 is activated, and transmits, to the PSA 12, a storage completion notification indicating that the print job has been received. The print job acquisition section 50 stores and accumulates, in the memory 2b, print jobs acquired from the PSA 12 and other applications.

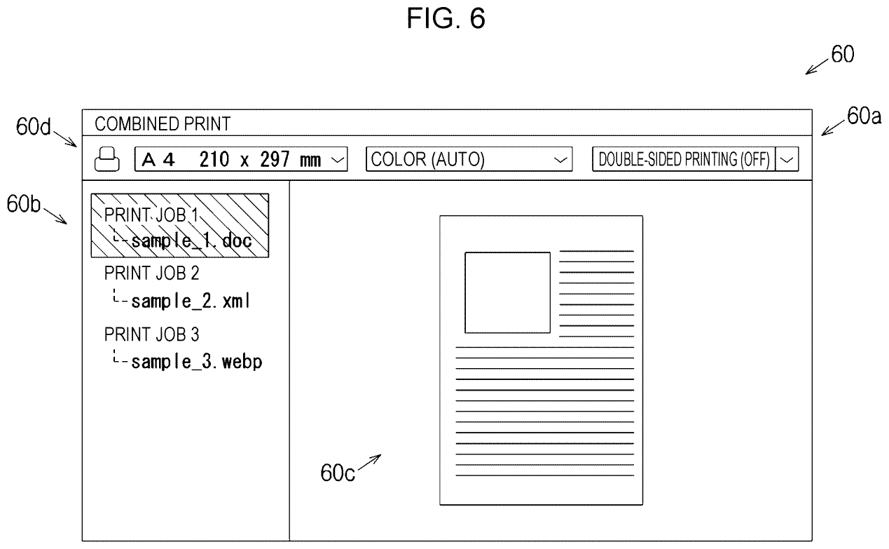

The display control section 51 displays a Windows form 60 as illustrated in FIG. 6 on the LCD 2e when the combined print application 13 is activated.

The Windows form 60 includes a print setting unit 60a, a print job list 60b, a print preview screen 60c, and a print execution button 60d.

The print setting unit 60a is typically composed of multiple pull-down menus so that the user can input print settings.

On the print job list 60b, the print jobs accumulated in the memory 2b by the print job acquisition section 50 are displayed.

On the print preview screen 60c, a preview of print data included in a print job in a selected state in the print job list 60b is displayed.

The print execution section 52 executes predetermined print processing in response to pressing of the print execution button 60d. Specifically, the print execution section 52 generates print setting information, based on the print settings input via the print setting unit 60a. Then, the print execution section 52 updates, based on the print setting information, the print setting information of the multiple print jobs displayed on the print job list 60b, and combines the multiple print jobs into one print job to execute printing. Combining multiple print jobs into one print job to execute printing includes, for example, executing double-sided printing so that print data of different print jobs are printed on the front and back sides of a sheet and inserting consecutive page numbers into print results of multiple print jobs.

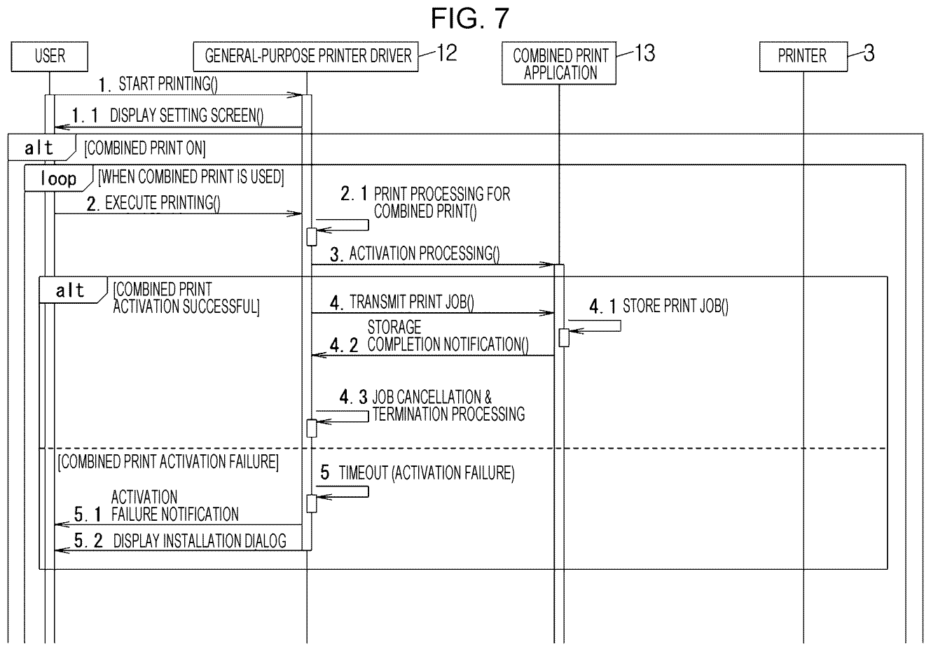

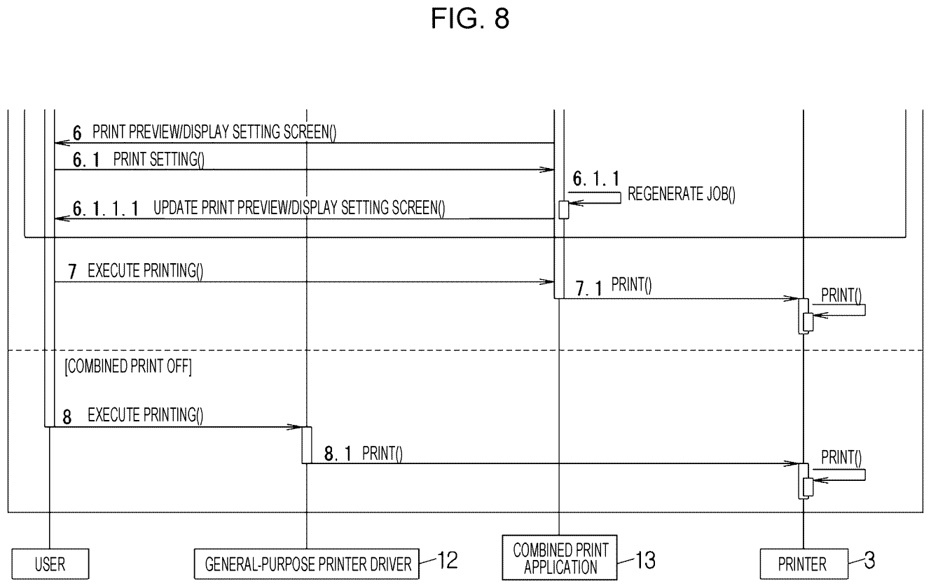

Next, an operation flow of the printing system 1 will be described with reference to FIGS. 7 and 8.

### Step 1

First, the user operates the image creation application 11 to start printing and presses the PSA calling button 15b illustrated in FIG. 3, thereby starting printing using the PSA 12. Specifically, the general-purpose printer driver 10a activates the PSA 12 and transmits the print job to the PSA 12.

### Step 1.1

Upon receiving the print job from the general-purpose printer driver 10a, the print job acquisition section 20 of the PSA 12 transmits a reception response to the general-purpose printer driver 10a, and displays the print setting dialog 30 illustrated in FIG. 4 on the LCD 2e.

### Step 2

Next, the user presses the print execution button 30d.

### Step 2.1

When the execution of the printing of the print job by the combined print application 13 is selected via the combined print application use selection unit 30b of the print setting dialog 30, the print execution section 22 executes the print processing for the combined print application 13. Specifically, the print execution section 22 notifies the user that the combined print application 13 is running by, for example, displaying a progress bar indicating that the combined print application 13 is running on the print setting dialog 30.

### Step 3

Next, the print execution section 22 of the PSA 12 activates the combined print application 13 when the combined print application 13 is not already running.

### Step 4

When the print execution section 22 receives an activation response from the combined print application 13, it determines that the activation of the combined print application 13 has been successful and transmits the print job to the combined print application 13.

### Step 4.1

The print job acquisition section 50 stores and accumulates, in the memory 2b, the print job received from the PSA 12.

### Step 4.2

The print job acquisition section 50 transmits the storage completion notification to the PSA 12.

### Step 4.3

When the print execution section 22 receives the storage completion notification from the combined print application 13, it cancels the print job held by the PSA 12 and executes the termination processing of the PSA 12.

### Step 5

When an activation response is not received from the combined print application 13 even after a predetermined time has elapsed since the print execution section 22 activated the combined print application 13, the notification section 23 executes the following process.

### Step 5.1

That is, the notification section 23 notifies the user via the LCD 2e that the activation of the combined print application 13 has failed.

### Step 5.2

In addition, the notification section 23 suggests the user to install the combined print application 13 by displaying the warning dialog 40 illustrated in FIG. 5 on the LCD 2e.

The accumulation of the print job in step 4.1 is executed every time the PSA 12 transmits the print job to the combined print application 13.

### Step 6

The display control section 51 displays the Windows form 60 illustrated in FIG. 6 on the LCD 2e.

### Step 6.1

The user changes the print settings via the print setting unit 60a.

### Step 6.1.1

The print execution section 52 updates the print job, based on the print settings input via the print setting unit 60a.

### Step 6.1.1.1

The display control section 51 updates the display contents of the print preview screen 60c, based on the updated print job.

### Step 7

Next, the user presses the print execution button 60d on the Windows form 60.

### Step 7.1

Then, the print execution section 52 of the combined print application 13 combines multiple print jobs displayed on the print job list 60b and executes printing as one print job. To be specific, the print execution section 52 of the combined print application 13 combines the multiple print jobs into one print job, and transmits the one print job to the general-purpose printer driver 10a or a printer driver provided by a vendor, thereby executing printing of the combined print job. As a result, the printer 3 executes printing of the combined print job.

### Step 8

The user presses the print execution button 30d in FIG. 4.

### Step 8.1

At this time, in a case where the execution of the printing of the print job by the combined print application 13 is not selected via the combined print application use selection unit 30b of the print setting dialog 30, the print execution section 22 executes the printing of the print job held by the PSA 12. To be specific, the print execution section 22 executes printing of the print job by transmitting the print job to the general-purpose printer driver 10a or a printer driver provided by a vendor. As a result, the printer 3 executes printing of the combined print job.

The embodiments of the present disclosure have been described above, and the above embodiments have the following features.

The print control program causes the computer 2 to function as the PSA 12 (print extension application) that extends the general-purpose printer driver 10a (general-purpose printer driver). The PSA 12 includes a print job acquisition section 20 (print job acquisition unit) that acquires a print job from the general-purpose printer driver 10a, and a display control section 21 (selection accepting unit) that accepts a selection of whether to cause the combined print application 13 (external application) to process the print job. According to the above-described configuration, it is possible to realize a function which cannot be achieved in the PSA 12 while avoiding the bloat of the PSA 12.

The combined print application 13 is a print application that executes printing of a plurality of print jobs as one print job. According to the above-described configuration, it is possible to realize a job combining function which is not installed in the PSA 12.

The PSA 12 further includes a print execution section 22 (print job transmission unit) that, when it is selected to cause the combined print application 13 to process the print job, activates the combined print application 13 and transmits the print job to the combined print application 13. According to the above configuration, the print processing of the print job can be taken over from the PSA 12 to the combined print application 13.

Additionally, the PSA 12 further includes the print execution section 22 (termination processing unit) that terminates the PSA 12 when a storage completion notification (notification) is received from the combined print application 13. According to the above configuration, it is possible to end the PSA 12 after the combined print application 13 reliably receives the print job.

Additionally, the PSA 12 further includes a notification section 23 (notification unit) that executes a notification related to the failure of the activation of the combined print application 13 when the activation of the combined print application 13 fails. According to the above configuration, the user can reliably recognize that the activation of the combined print application 13 has failed.

Although the present disclosure has been described with reference to embodiments, the present disclosure is not limited to the above description. Various changes can be made to the configuration and details of the present disclosure within the scope of the disclosure that would be understood by those skilled in the art.

In the above example, the program can be stored by using various types of non-transitory computer readable media and can be supplied to the computer. The non-transitory computer readable medium includes various types of tangible storage media. Examples of non-transitory computer readable media include magnetic recording media (for example, a flexible disk, a magnetic tape, and a hard disk drive) and magneto-optical recording media (for example, a magneto-optical disk). Examples of non-transitory computer readable media further include compact disk read-only memory (CD-ROM), CD-R, CD-R/W, and semiconductor memory (for example, mask ROM). Examples of non-transitory computer readable media further include programmable ROM (PROM), erasable PROM (EPROM), flash ROM, and random access memory (RAN). The program may be supplied to the computer by various types of transitory computer readable media. Examples of the transitory computer readable media include an electrical signal, an optical signal, and an electromagnetic wave. The transitory computer readable medium can supply a program to a computer via a wired communication path such as an electrical wire and an optical fiber or a wireless communication path.

What is claimed is:

1. A non-transitory computer-readable storage medium storing a print control program, the print control program causing a computer to function as a print extension application for extending a general-purpose printer driver,
wherein the print extension application includes
a print job acquisition unit configured to acquire a print job from the general-purpose printer driver, and
a selection accepting unit configured to accept a selection of whether to cause an external application to process the print job.

2. The non-transitory computer-readable storage medium storing a print control program according to claim 1,
wherein the print extension application is a print support application.

3. The non-transitory computer-readable storage medium storing a print control program according to claim 1,
wherein the external application is a print application that executes printing of a plurality of print jobs as one print job.

4. The non-transitory computer-readable storage medium storing a print control program according to claim 1,
wherein the print extension application further includes a print job transmission unit configured to, when it is selected to cause the external application to process the print job, activate the external application and transmit the print job to the external application.

5. The non-transitory computer-readable storage medium storing a print control program according to claim 4,
wherein the print extension application further includes a termination processing unit configured to terminate the print extension application when a notification is received from the external application.

6. The non-transitory computer-readable storage medium storing a print control program according to claim 4,
wherein the print extension application further includes a notification unit configured to execute a notification related to failure of the activation of the external application when the activation of the external application fails.

7. The non-transitory computer-readable storage medium storing a print control program according to claim 4,
wherein the print extension application further includes a notification unit configured to execute a notification related to a fact that the external application is not installed when the external application is not installed.

8. A print control apparatus comprising:
a general-purpose printer driver; and
a print extension application configured to extend the general-purpose printer driver,
wherein the print extension application includes
a print job acquisition unit configured to acquire a print job from the general-purpose printer driver, and
a selection accepting unit configured to accept a selection of whether to cause an external application to process the print job.

9. A control method for a print control apparatus including
a general-purpose printer driver, and
a print extension application configured to extend the general-purpose printer driver,
the control method comprising:
acquiring, by the print extension application, a print job from the general-purpose printer driver; and
accepting, by the print extension application, a selection of whether to cause an external application to process the print job.
